(19) United States
(12) Patent Application Publication
(10) Pub. No.: US 2004/0122748 A1
(43) Pub. Date: Jun. 24, 2004

(54) Method and system for creating an inventory

(76) Inventor: Kachur Donald, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 09/791,672

(22) Filed: Feb. 26, 2001

Related U.S. Application Data
(60) Provisional application No. 60/184,655, filed on Feb. 24, 2000.

(51) Int. Cl. G06F 17/60

(52) U.S. Cl. 705/28

(57) ABSTRACT

A computer system and method for creating an inventory of items to be moved by a commercial moving service include client and server software which communicate over a network such as the internet or a local area network. During a session, a user is prompted to select items to be added to the inventory by clicking on graphical icons which represent the item chosen. The items may be grouped hierarchically. The client transmits item selections to the server where an inventory including a list of the items, their cumulative weight and volume is calculated based on stored data which includes standardized or customized weights and volumes for the items selected. A price quote may be generated from the inventory by applying tariffs or estimated distances from geographic information entered by the user. The system and method may be implemented on a portable computing device as an alternative to a client/server system.

This application claims priority to U.S. Provisional Patent Application No. 60/184,655, filed on Feb. 24, 2000 and entitled “Method And System For Creating An Inventory”.

### FIELD OF THE INVENTION

The present invention relates to a computer method and system for creating an inventory of goods to be moved by a moving service.

### BACKGROUND OF THE INVENTION

It is very common in the commercial moving industry to provide fixed price quotes for moving household or commercial goods. An accurate inventory of all items to be moved is a fundamental requirement for a fair fixed price quote system. An inventory is created by first ascertaining the number and description of items to be moved and then using industry standards to calculate the total weight and/or volume of the items. The resulting calculation forms the basis for providing the fixed price quote.

Typically, an inventory may be taken on-site by an employee of the moving company using a manual system known as a “cube sheet”. Alternatively, inventories may be taken over the telephone by interviewing the customer and completing a manual cube sheet remotely. This method is subject to calculation errors and does not produce a legible printed inventory for verification or audit purposes. Without a printed inventory, it is impossible for either the customer or the moving company to audit the contents of the move to determine if all the items to be moved were included in the quote.

Customer created inventories are often unreliable because of the tendency of the customer to underestimate the items to be moved or to omit items and because of the uncertainty in name or description of certain items. For example, large overstuffed armchairs may be treated differently than dining room chairs or a small TV stand may be treated differently from an entertainment unit yet there may be some confusion as to what is actually intended to be included in the inventory. One must also guard against “bumping” of the weight of a shipment by unscrupulous movers where the price is based on an agreed price per pound. It would be advantageous to have a system which permits an audit process to verify the scaled weight against the estimated weight.

Therefore, there is a need in the art for a method and system of creating an inventory of goods to be moved while automatically calculating the volume and weight of the goods which mitigates the difficulties of the prior art. It would be advantageous is such a method and system permitted a customer to create and verify such an inventory.

### SUMMARY OF THE INVENTION

In one aspect, the invention comprises a method of creating an inventory of a plurality of items, including an estimate of the total weight and/or volume for the inventory, said method comprising:

(a) under control of a client system, receiving a user input for creating a user identifier and sending the user identifier to a server system; displaying a plurality of icons wherein each icon represents a specific item; and in response to a user input indicating choice of an item, sending an inventory item information to the server system; and

(b) under control of the server system, receiving and storing the user identifier;

receiving the inventory item information and adding the item to a listing of items associated with the user identifier, creating a cumulative total weight of the items in the listing by reading data comprising specific items and their weights and/or creating a cumulative total volume of the items in the listing by reading data comprising specific items and their volumes and writing or storing the listing, its associated weight and/or volume to an inventory file or dataset.

In one embodiment, each icon graphically represents the specific item and the plurality of icons are displayed in hierarchical groups. The groups represent groupings of furniture items typically found in domestic rooms such as kitchen, living room or dining room. There may be subgroups wherein each subgroup comprises different alternative items related by furniture type. For example, under a group of dining room furniture, there may be a subgroup of dining room tables having dining room tables of different sizes or styles. The method may further comprise the steps of, under control of the client system, receiving a user input identifying the origin and the destination of a move and sending origin and destination information to the server system; and, under control of the server system, receiving the origin and destination information, and creating a distance estimate by reading data comprising specific distances between known geographic markers.

Optionally, the method may also comprise the step of creating a price quote for the move in the server system and communicating the quote to the client system for display to the user.

In another aspect, the invention may comprise a method of creating an inventory listing of a plurality of items, including an estimate of the total weight and volume for the inventory, said method using a client system and comprising:

(a) receiving user inputs to create a user identifier and sending the user identifier to a server system;

(b) displaying a plurality of icons wherein each icon represents a specific item;

(c) in response to a user input indicating choice of an item, sending an item identifier to the server system and a request that the item represented by the icon, and its weight and volume, be added to the inventory listing; and

(d) in response to a user input indicating completion, requesting from the server system and receiving the inventory listing.

The inventory listing may comprise a list of each item chosen by the user, the total weight, and/or the total volume of all the items chosen.

In another aspect, the invention may comprise a method of creating an inventory listing of a plurality of items, including an estimate of the total weight and/or volume for the inventory, said method using a server system and comprising:

(a) receiving from a client system a user identifier and a plurality of item identifiers;

(b) creating an inventory listing specific to the user identifier comprising a list of each item associated with each item identifier and cumulative weight of the items and/or the cumulative volume of the items; and

(c) sending the inventory listing to the client system after each item identifier is received and acted upon or upon a request signifying completion of receipt of item identifiers.

This method may further comprise the steps of receiving from the client system an origin identifier and a destination identifier, estimating the physical distance between the origin and the destination by reading data comprising known distances between geographic markers, calculating a price quote based on the inventory listing and the physical distance and sending the quote to the client system.

In another aspect, the invention may comprise a method of creating an inventory of a plurality of items, including an estimate of the total weight and/or volume for the inventory, said method comprising:

(a) providing a data file of potential inventory items and an value for weight and/or volume associated with each item;

(b) creating a user identifier and storing the user identifier in an inventory dataset;

(c) displaying a plurality of icons wherein each icon represents a specific item;

(d) choosing items by choosing the representative icon; and

(e) updating the inventory file with each item chosen thereby creating a cumulative total weight of the items in the listing by reading data comprising specific items and their weights and/or creating a cumulative total volume of the items in the listing by reading data comprising specific items and their volumes and writing the listing, its associated weight and/or volume to the inventory dataset.

In its apparatus form, the invention may comprise a server system for creating an inventory of a plurality of items, including an estimate of the total weight and volume for the inventory, said system comprising:

(a) a data storage medium including a database comprising a listing of a plurality of items which may be included in the inventory, including a weight value and a volume value for each such item;

(b) a client communicating component;

(c) means for receiving user inputs from the client system indicating user identity and choice of specific items to be included in the inventory;

(d) an inventory dataset associated with or including the user identity; and

(e) means for looking up the database in response to an item choice and relating data comprising the name of the item, its weight and/or its volume in the inventory dataset.

In another aspect, the invention may comprise a computer system for creating an inventory of a plurality of items, including an estimate of the total weight and/or volume for the inventory, said method comprising:

(a) a data storage medium comprising a database of potential inventory items and a value for weight and/or volume associated with each item;

(b) means for receiving a user input for creating a user identifier and storing the user identifier in an inventory dataset;

(c) means for displaying a plurality of icons wherein each icon represents a specific item;

(d) means for receiving a user input indicating choice of an item

(e) means for adding an inventory item information to the inventory dataset; and

(f) means for updating the inventory dataset with each item chosen by the user thereby creating a cumulative listing of the items in the inventory by reading data comprising specific item(s) and their weight(s) and/or volume(s).

In one embodiment, the plurality of icons are organized in hierarchical groups as indicated above. The database may further comprises a table of distances between known geographic markers. The system may further comprise:

(a) means for receiving a user input identifying the origin and the destination of a move; and

(b) means for creating a distance estimate which is added to the inventory dataset;

(c) means for creating a monetary quote for the move and adding the quote to the inventory dataset; and

(d) means for displaying or printing the inventory dataset.

### BRIEF DESCRIPTION OF THE DRAWINGS

FIG. 1 is a block diagram illustrating an embodiment of the present invention.

FIG. 2 is a block diagram of an alternative embodiment of the present invention.

FIG. 3 is a flow diagram of a routine illustrating a method of the present invention.

FIG. 4 is a flow diagram of a routine illustrating a method of the present invention from the client point of view.

FIG. 5 is a flow diagram of a routine illustrating a method of the present invention from a server point of view.

### DETAILED DESCRIPTION OF THE INVENTION

The present invention provides a method and system for creating an inventory of the contents of a household or a business for the purpose of moving those contents from one location to another and to permit the mover to allocate van space to accomplish the move. The inventory comprises a listing of a plurality of items, including an estimate of the total weight and/or volume for the total inventory. All terms used herein have their common art-recognized meanings.

The foregoing description includes one embodiment of the invention based on a client-server model. In this embodiment, part of the system resides on a computer at the location being moved and part of the system resides on the moving company's central computer. A client-server based system could be deployed using the Internet, two-way pager, cellular or satellite communications or by using modems over telephone lines to permit the two computers and software to communicate. The client portion of the system may consist of software residing on a hand-held, mobile or desktop computer and the server portion of the system may consist of software located on a central computer. A communications link between the client software and the server software allows for interaction between the two, as is well known in the art.

One skilled in the art will appreciate that a server system may comprise any combination of hardware and software that can generate an inventory in response to the appropriate user inputs. A client system may comprise any combination of hardware and software that can interact with the server system. These systems may include television based systems or various other consumer products.

Alternatively, the entire system may be contained on a single computer or hand-held unit. With this implementation, the operating elements of the client system and server system may not be distinct and there would be no need for the communications subsystem between the client software and the server software. If the software is deployed without a communications subsystem then the system components could communicate with one another through an application programming interface, as is well-known in the art. Where the system is contained on a single computer or handheld unit, the system may still include a communications subsystem allowing the system to periodically synchronize with a master system on another computer. For example, updates to the database and completed inventories may be stored on the master computer and may be downloaded to the system periodically. A user may then modify an existing inventory on the system and the modified inventory, along with any completed inventories stored in the system, may then be uploaded to the master computer during the next synchronization.

In one embodiment, the client portion of the system may in fact reside on the server and be delivered to the client computer when requested. This may occur if, for example, a web based deployment is used and the client software consists of one or more web pages, JavaScripts, Java Applets and so forth. This portion of the software would, however, run on the client computer once delivered.

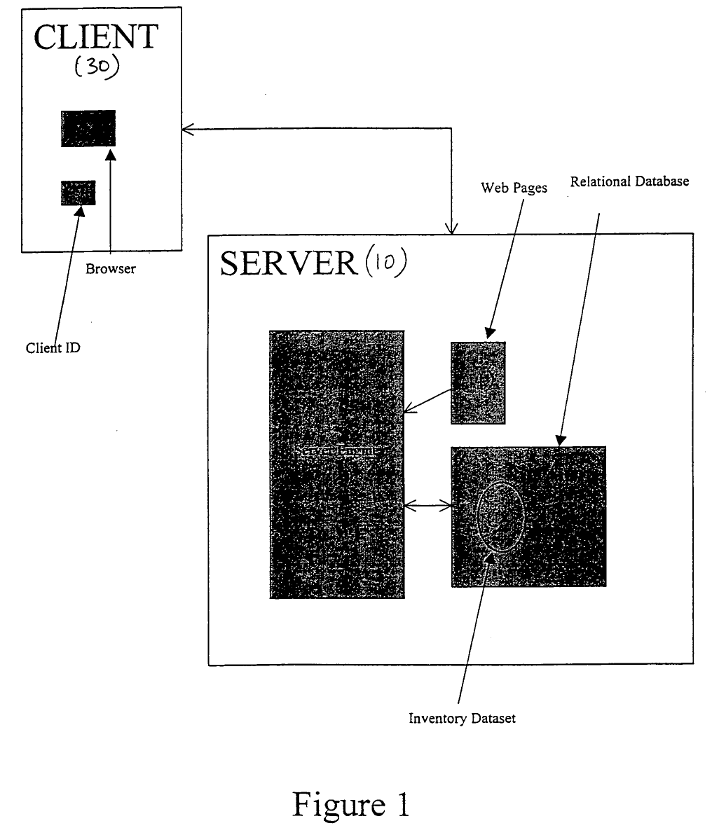

FIG. 1 is a block diagram illustrating an embodiment of the present invention. This embodiment supports the system over the Internet using the World Wide Web. Of course, the communication channel may be a local area network, a wide area network or a point-to-point dial up connection, as is well known in the art. In one embodiment, the user is a customer who 25 wishes to obtain a quote from a mover and accesses the mover's website to do so.

The server system (10) includes a server engine (12), various Web pages (14), a relational database (16) which includes a data library and inventory information (18). The server engine receives HTTP requests to access the Web pages identified by URL's and provides the Web pages to the requesting client system (30). The data library contains information about items which could be part of an inventory including weights and volumes for each item. The weight and volume data may be derived from industry standards or be customized by the mover. The data library may also contain distance information between known geographical landmarks or zones and other information necessary to provide accurate quotes.

The client system (30) contains the user interface. In one embodiment, the client implementation may be web based and will therefore use a web browser (32) and XML, HTML, Java Applets and so forth. The client system (30) may also contain a client identifier (34), which may be stored in a file as a “cookie”. In one embodiment, the server system (10) assigns and sends the client identifier (34) to the client system (30) once when the client system first interacts with the server system. From then on, the client system (30) includes its client identifier (34) with all messages sent to the server system so that the server system can identify the source of the message.

The browser (32) permits the user to send HTTP requests to access Web pages (14) stored on the server system (10) identified by URL's. The Web pages allow the user to provide information related to the move, for example, the addresses of the old and new locations, names, dates, special instructions, insurance requirement, credit card information and so forth. The user may then be presented with Web pages including icons or other means of graphical representation representing household items from which to choose.

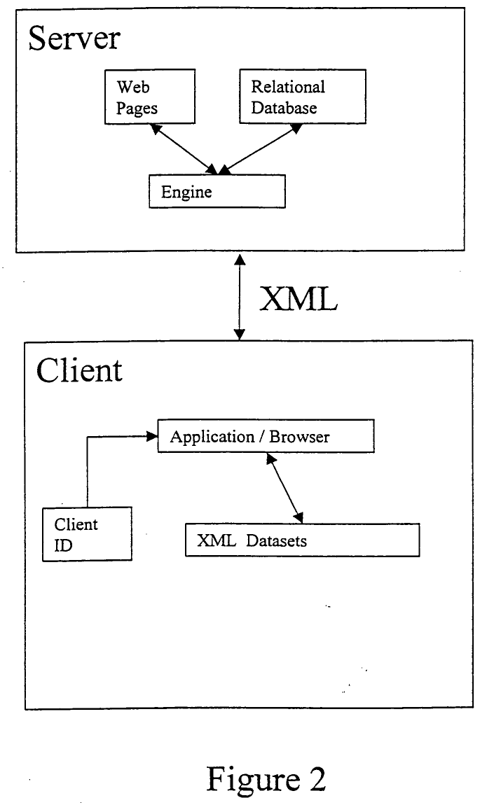

FIG. 2 is a block diagram illustrating an alternative embodiment of the invention. In this case the client system comprises a computer which may implement the method disclosed herein on a stand-alone basis. There is no client-server differentiation in this case. Optionally, the client system may comprise a communication component for connecting to and synchronizing with a server or master computer. Upon synchronization, the database of tariff, weight and volume figures on the client computer may be updated with a master database resident on the server. Completed inventories on the client may be copied or transferred to the server while completed inventories or partially completed inventories on the server may be copied or transferred to the client. The client may then be used offline to modify an inventory or complete a partially completed inventory. This embodiment is suited for use by a mover's employee using a portable computing device such as a laptop or handheld computer. The employee would visit the potential customer's site, create the inventory on the portable computer and return to “sync” the portable computer with a server or master computer. The customer may then view or download the inventory and quote from the mover's website.

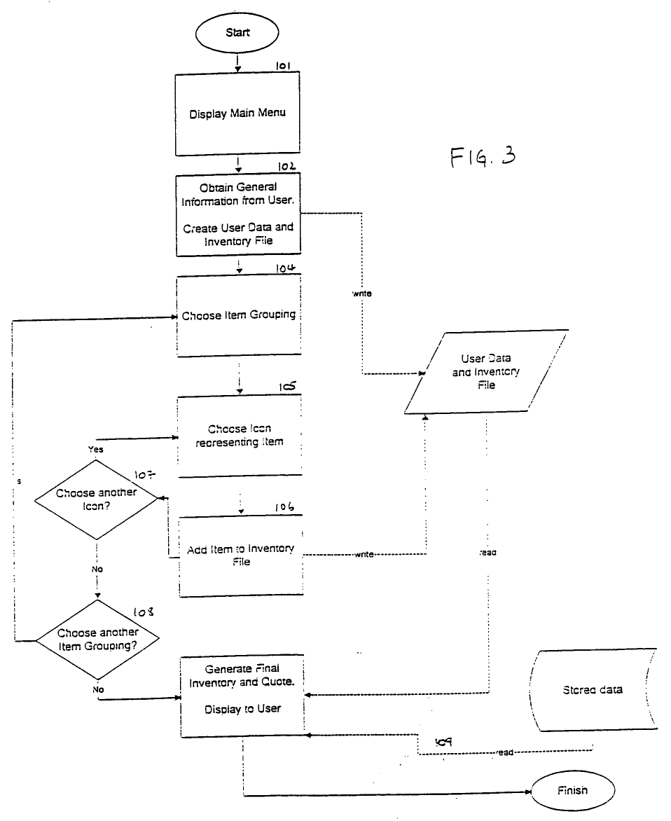

FIG. 3 is a flow diagram of a routine that illustrates one embodiment of a method of the invention. In an initial step (101), the client may request a Web page having a main menu which is presented to the user. The server may require the user to “login” so that the identity of the user may be verified if necessary or desired. The main menu permits the user to initiate a new inventory, or add to or modify an existing inventory. If a new inventory is being initiated, then the user may be prompted to enter identifying information in step 102. User inventory information is then created (103). The user may then be presented with a plurality of icons which represent particular items which could be included in the inventory. In a preferred embodiment, the icons may be divided into sets of logical groupings. For example, in a residential household move, the sets may include groupings by room (living room, dining room, master bedroom etc.) and/or by type (major appliances). The sets themselves may be divided into subsets. For example, one set may comprise a living room grouping containing icons representing items typically found in a living room. The set may include a subset of sofas where the subset comprises sofas of different types or styles where each different type or style will be treated differently by the system in creating the inventory. The server would deliver a set or subset of icons to the client software for display to the user when a particular grouping is requested by the user (104).

The user may then create the inventory of the content of their household or office by selecting, by mouse clicks or otherwise, the icon most closely representing the actual item (105). The icons displayed to the user should preferably provide a graphical representation of the type of item such that its choice is intuitive or easy. The client software may keep track of these items and then submit them to the server when the inventory is complete or the information may be submitted to the server as each item is selected by the user (105). The server may then store this information in the inventory file or dataset (106).

When information is received by the server, either as when items are selected or when the inventory is complete, the server may then store this information such that all information relating to the user or location is easily retrievable.

When the server creates an inventory, either on an ongoing basis or when the inventory is complete, the server may look up the volume and/or weight for each item. This information could be retrieved (108) from tables or a database containing an association between the item and industry standards for the weight and volume of that item. Optionally information supplied by the user may also be used to determine a more accurate estimate of the weight and volume.

Once the weight and volume have been determined for each item these amounts may then be totaled for all items (109). The calculation may be done on an ongoing cumulative basis as each item is chosen or a final calculation done when the item choosing process has been completed. Optionally, the server may then calculate a quote which would be displayed to the user by the client software. The quote could be derived from tables or a database containing an association between prices and weights and volumes and a calculation based on distance. The server may then forward the quote information for the move to the client as the session progresses, for example, as each item is selected or when the inventory is complete.

The server may accommodate many users and clients simultaneously. Depending on the implementation, this could be done by using cookies or sessionids to keep track of the user, as is well-known in the art.

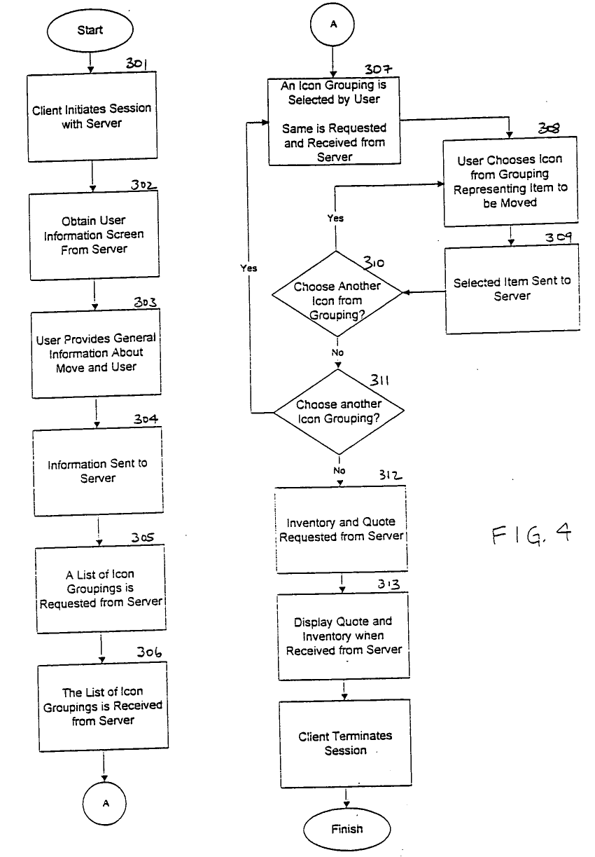

FIG. 4 is a flow diagram of a routine which shows the steps of the present invention from the point of the view of the client. In steps 301 and 302, the client initiates a session with the server and receives a user information screen. The client provides user information which is sent to the server in steps 303 and 304. In steps 305 to 313, the client may then request and receive a screen having the icon groupings and begin the process of choosing icons, causing the server to add items to an inventory file. When that process is complete, the client may request, receive and display the final quote and inventory listing.

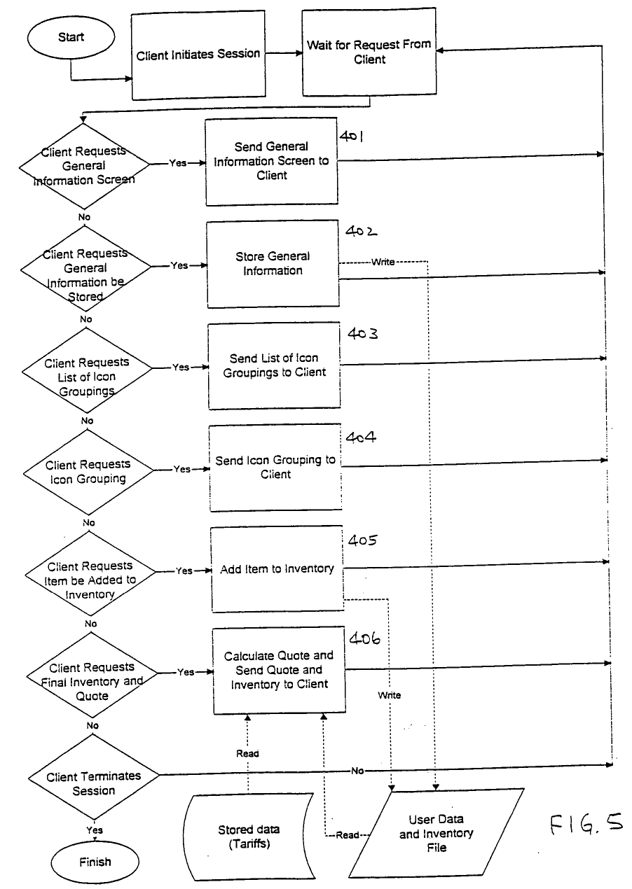

FIG. 5 is a flow diagram of a routine which shows the steps of the present invention from the point of view of the server. In step 401, the server sends the general information screen to the client in response to a client request. After the client inputs and sends the necessary information, the server may then store that information in the inventory file in step 402. In step 403, the server sends a listing of icon groupings to the client and in step 404, sends a single icon grouping to the client in response to a client request. In step 405, the server adds a specific item to the inventory file in response to a client request. In step 406, once all the chosen items have been added to the inventory file, a final inventory listing may be compiled by the server and a quote produced. The quote may be based on a distance estimate or tariff based on geographic information entered by the user identifying origin and destination of the move.

It will be apparent to one skilled in the art that the routines shown in FIGS. 3, 4 and 5 may be combined into one routine which may be implemented in an embodiment of the invention where the method is carried out on a single stand-along computer, as is shown in FIG. 2. In that case, references to client and server may be conceived of as references to different components of an application running on the stand-alone computer which communicate via an application programming interface.

Alternatively, the completed inventory listing, including weights and volumes, may be posted by the user to a site accessible by a number of different moving companies who could then bid on the move in an auction or secret or open bid type process. The standardization of the inventory listing permits the different moving companies to bid on an equal footing.

Although the present invention has been described in relation to creating an inventory of goods for moving purposes, it may be practiced or adapted for other purposes, including creating an inventory for insurance purposes or for archival purposes.

As will be apparent to those skilled in the art, various modifications, adaptations and variations of the foregoing specific disclosure can be made without departing from the scope of the invention claimed herein.

What is claimed is:

1. A method of creating an inventory of a plurality of items, including an estimate of the total weight and/or volume for the inventory, said method comprising:
(a) under control of a client system, receiving a user input for creating a user identifier and sending the user identifier to a server system; displaying a plurality of icons wherein each icon represents a specific item; and in response to a user input indicating choice of an item, sending an inventory item information to the server system; and
(b) under control of the server system, receiving and storing the user identifier;
receiving the inventory item information and adding the item to a listing of items associated with the user identifier, creating a cumulative total weight of the items in the listing by reading data comprising specific items and their weights and/or creating a cumulative total volume of the items in the listing by reading data comprising specific items and their volumes and writing or storing the listing, its associated weight and/or volume to an inventory file or dataset.

2. The method of claim 1 wherein each icon graphically represents the specific item.

3. The method of claim 2 wherein the plurality of icons are displayed in hierarchical groups.

4. The method of claim 3 wherein the hierarchical groups represent groupings of furniture items typically found in domestic rooms such as kitchen, living room or dining room.

5. The method of claim 4 further comprising subgroups wherein each subgroup comprises different alternative items related by furniture type.

6. The method of claim 1 further comprising the steps of, under control of the client system, receiving a user input identifying the origin and the destination of a move and sending origin and destination information to the server system; and, under control of the server system, receiving the origin and destination information, and creating a distance estimate by reading data comprising specific distances between known geographic markers.

7. The method of claim 6 further comprising the step of creating a price quote for the move in the server system and communicating the quote to the client system for display to the user.

8. A method of creating an inventory listing of a plurality of items, including an estimate of the total weight and volume for the inventory, said method using a client system and comprising:
(a) receiving user inputs to create a user identifier and sending the user identifier to a server system;
(b) displaying a plurality of icons wherein each icon represents a specific item;
(c) in response to a user input indicating choice of an item, sending an item identifier to the server system and a request that the item represented by the icon, and its weight and volume, be added to the inventory listing; and
(d) in response to a user input indicating completion, requesting from the server system and receiving the inventory listing.

9. The method of claim 8 wherein the inventory listing comprises a list of each item chosen by the user, the total weight, and/or the total volume of all the items chosen.

10. A method of creating an inventory listing of a plurality of items, including an estimate of the total weight and/or volume for the inventory, said method using a server system and comprising:
(a) receiving from a client system a user identifier and a plurality of item identifiers;
(b) creating an inventory listing specific to the user identifier comprising a list of each item associated with each item identifier and cumulative weight of the items and/or the cumulative volume of the items; and
(c) sending the inventory listing to the client system after each item identifer is received and acted upon or upon a request signifying completion of receipt of item identifiers.

11. The method of claim 8 further comprising the steps of receiving from the client system an origin identifier and a destination identifier, estimating the physical distance between the origin and the destination by reading data comprising known distances between geographic markers, calculating a price quote based on the inventory listing and the physical distance and sending the quote to the client system.

12. A method of creating an inventory of a plurality of items, including an estimate of the total weight and/or volume for the inventory, said method comprising:
(a) providing a data file of potential inventory items and an value for weight and/or volume associated with each item;
(b) creating a user identifier and storing the user identifier in an inventory dataset;
(c) displaying a plurality of icons wherein each icon represents a specific item;
(d) choosing items by choosing the representative icon; and
(e) updating the inventory file with each item chosen thereby creating a cumulative total weight of the items in the listing by reading data comprising specific items and their weights and/or creating a cumulative total volume of the items in the listing by reading data comprising specific items and their volumes and writing the listing, its associated weight and/or volume to the inventory dataset.

13. The method of claim 12 wherein each icon graphically represents the specific item.

14. The method of claim 13 wherein the plurality of icons are displayed in hierarchical groups.

15. The method of claim 14 wherein the hierarchical groups represent groupings of furniture items typically found in domestic rooms such as kitchen, living room or dining room.

16. The method of claim 15 further comprising subgroups wherein each subgroup comprises different alternative items related by furniture type.

17. The method of claim 12 further comprising the steps of receiving a user input identifying the origin and the destination of a move, providing and reading data comprising specific distances between known geographic markers and creating a distance estimate which is added to the inventory dataset or displayed.

18. The method of claim 17 further comprising the step of creating a price quote for the move and adding the quote to the inventory dataset or displaying the quote.

19. A server system for creating an inventory of a plurality of items, including an estimate of the total weight and volume for the inventory, said system comprising:
(a) a data storage medium including a database comprising a listing of a plurality of items which may be included in the inventory, including a weight value and a volume value for each such item;
(b) a client communicating component;
(c) means for receiving user inputs from the client system indicating user identity and choice of specific items to be included in the inventory;
(d) an inventory dataset associated with or including the user identity; and
(e) means for looking up the database in response to an item choice and relating data comprising the name of the item, its weight and/or its volume in the inventory dataset.

20. A computer system for creating an inventory of a plurality of items, including an estimate of the total weight and/or volume for the inventory, said method comprising:
(a) a data storage medium comprising a database of potential inventory items and a value for weight and/or volume associated with each item;
(b) means for receiving a user input for creating a user identifier and storing the user identifier in an inventory dataset;
(c) means for displaying a plurality of icons wherein each icon represents a specific item;
(d) means for receiving a user input indicating choice of an item
(e) means for adding an inventory item information to the inventory dataset; and
(f) means for updating the inventory dataset with each item chosen by the user thereby creating a cumulative listing of the items in the inventory by reading data comprising specific item(s) and their weight(s) and/or volume(s).

21. The system of claim 20 wherein the plurality of icons are organized in hierarchical groups.

22. The system of claim 20 wherein the database further comprises a table of distances between known geographic markers and the system further comprises:
(a) means for receiving a user input identifying the origin and the destination of a move; and
(b) means for creating a distance estimate which is added to the inventory dataset.

23. The system of claim 22 further comprising means for creating a monetary quote for the move and adding the quote to the inventory dataset.

24. The system of claim 23 further comprising means for displaying or printing the inventory dataset.
